(19) United States
(12) Patent Application Publication
(10) Pub. No.: US 2025/0118796 A1
(43) Pub. Date: Apr. 10, 2025

(54) Solid-State Electrolytes based on rare-earth and transition metal coordination compounds for all-solid-state batteries

(71) Applicant: Joseph Carmine Magnotti, Tampa, FL (US)

(72) Inventor: Joseph Carmine Magnotti, Tampa, FL (US)

(21) Appl. No.: 18/445,552

(22) Filed: Oct. 10, 2023

(51) Int. Cl. H01M 10/0562

(52) U.S. Cl. CPC H01M 10/0562; H01M 2300/0068

(57) ABSTRACT

A method for the preparation of novel inorganic and cost-effective solid-state electrolytes is disclosed that exhibit an ionic conductivity of 3.6 mS·cm⁻¹, provide maximum solid-solid contact between the electrolyte and the electrodes in an electrochemical cell, require no special handling and storage, and are prepared at room temperature and atmospheric pressure. The electrolytes provide a solution to the problems of traditional lithium-based batteries using liquid electrolytes, and meet the essential requirements for the manufacture of all-solid-state batteries.

### REFERENCES CITED

1. Bachman, John C.; “Inorganic Solid-State Electrolytes for Lithium Batteries: Mechanisms and Properties Governing Ion Conduction”; Chem. Rev. 116 (1), 140-162 (13 Jan. 2016).
2. Chandler, David L.; “Study Suggests Route to Improving Rechargeable Lithium Batteries”; MIT News (12 Jul. 2017)
3. Chandler, David L.; “Toward All-Solid-State Lithium Batteries”; MIT News (2 Feb. 2017).
4. Wang, Yuchen, et. al.; “Greatly Enhanced Energy Density of All-Solid-State Rechargeable Battery Operating in High Humidity Environments”; Intl. Journal of Energy Research 45 (11), 16794-16805 (September 2021).
5. Akin, Mert, et. al.; “Effect of Relative Humidity on the Reaction Kinetics in Rubidium Silver Iodide Based All-Solid-State Battery”; Electrochimica Acta. 355, 136779 (September 2020).
6. Chen, Rusong, et. al.; “The Thermal Stability of Lithium Solid Electrolytes with Metallic Lithium”; Joule 4, 812-821 (April 2020).
7. Li, Xiona, et. al.; “Air-Stable Li₃InCl₆ Electrolyte with High Voltage Compatibility for All-Solid-State Batteries”; Energy and Env. Sci. 12 (9), 2665-2671 (2019).
8. Schlem, Roman, et. al.; “Mechanochemical Synthesis: A Tool to Tune Cation Site Disorder and Ionic Transport Properties of Li₃MCl₆ (M=Y, Er) Superionic Conductors”; Advanced Energy Materials 10 (6), 1903719 (February 2020).
9. Zhou, Laidong, et. al.; “A New Halospinel Superionic Conductor for High-Voltage All-Solid-State Lithium Batteries”; Energy and Env. Sci. 13 (7), 2056-2063 (2020).
10. Hu, Lv, et. al.; “A Cost-Effective, Ionically Conductive and Compressible Oxychloride Solid-State Electrolyte for Stable All-Solid-State Lithium-Based Batteries”; Nat. Comm. 14, 1-12 (27 Jun. 2023).
11. Zhang, Z., et. al.; “New Horizons for Inorganic Solid-State Ion Conductors”; Energy and Env. Sci. 11, 1945-1976 (2018).
12. Ren, Y., et. al.; “Oxide Electrolytes for Lithium Batteries”; J. Am. Ceram. Soc. 98, 3603-3623 (2015).
13. Famprikis, T., et. al.; “Fundamentals of Inorganic Solid-State Electrolytes for Batteries”; Nat. Mat. 18, 1278-1291 (2019).
14. Li, Xiano, et. al.; “Progress and Perspectives on Halide Lithium Conductors for All-Solid-State Lithium Batteries”; Energy and Env. Sci. 13, 1429-1461 (2020).
15. Wang, K., et. al.; “A Cost-Effective and Humidity-Tolerant Chloride Solid Electrolyte For Lithium Batteries”; Nat. Comm. 12, 4410 (2021).
16. Yang, Chongyin, et. al.; “All-Temperature Zinc Batteries with High-Entropy Aqueous Electrolyte”; Nat. Sustainability 6, 325-335 (9 Jan. 2023).
17. Liu, Yuhgene, et. al.; “Aluminum Foil Negative Electrodes with Multiphase Microstructure for All-Solid-State Li-ion Batteries”; Nat. Comm. 14, 3975 (2023).
18. Pang, Q., et. al.; “Fast-Charging Aluminum-Chalcogen Batteries Resistant to Dendritic Shorting”; Nature 608, 704-711 (2022).
19. Taewon, Kim, et. al.; “Prussian Blue-Type Sodium-ion Conducting Solid Electrolytes for All-Solid-State Batteries”; Angewandte Chemie Intl. Ed. (2023).

### TECHNICAL FIELD

This invention relates to the technology and physical chemistry of electrical energy storage; in particular, all-solid-state batteries and suitable solid-state electrolytes (SSEs) and a method for preparation of cost-effective SSEs with ionic conductivity and applicability superior to what is currently available.

### BACKGROUND OF THE INVENTION

Lithium-ion batteries (LIBs) currently dominate the market for electrical energy storage. Solid-state batteries can solve many problems associated with traditional LIBs, which use liquid or gel electrolytes. The solid-state construction offers higher energy density, improved safety, the elimination of leakage (a common problem in LIBs), the ability to be charged at higher voltage, and less susceptibility to unstable solid-electrolyte interphase (SEI) formation, i.e. dendrites, than mainstream LIBs.

Identifying appropriate solid electrolytes is the primary requirement for construction of solid-state batteries. The solid electrolyte needs to exhibit an ionic conductivity of at least 1 mS·cm⁻¹, a compressibility of at least 90% density under 300 MPa of pressure and be cost-effective. Another important feature of a solid-state electrolyte is the ratio of its electrical conductivity to the ionic conductivity, which needs to be as low as possible to prevent leakage current between the two electrodes ¹.

Candidate materials for SSEs have included ceramics such as Li₄SiO₄², glasses, sulfides ³, and RbAg₄I₅^{4.5}. Solid oxide electrolytes include Li_{1.5}Al_{0.5}Ge_{1.5} (PO₄)₃, Li_{1.4}Al_{0.4}Ti_{1.6} (PO₄)₃, perovskite-type Li₃ₓLa_{2/3-x}TiO₃, and garnet-type Li_{6.4}La₃Zr_{1.4}Ta_{0.6}O₁₂ with metallic Li ⁶. Chloride-based solid electrolytes include Li₃MCl₆^{7,8} and Li₂M_{2/3}Cl₄⁹, where M is one of the following elements: Y, Sc, In, Tb, Dy, Ho, Er, Tm, Yb, or Lu. Most recently, the oxychloride-based solid electrolyte Li_{1.75}ZrCl_{4.75}O_{0.5} was reported by Lv Hu, et. al. ¹⁰.

The ionic conductivity of an SSE is an essential property, because the efficiency of ion-transport within the electrolyte determines its energy density, so that less space is required to store a given amount of electrical energy in the battery. The compressibility of an SSE determines the sufficiency of electrode-electrolyte contact-greater contact means less resistance and increased battery performance-so that higher compressibility is desirable. Finally, the cost of materials for the manufacture of an SSE should not exceed $50 per kilogram in order to be competitive in the market for commercial lithium-ion batteries.

The oxides generally cannot meet the requirement for compressibility, as they are brittle solids ^{11,12}. The sulfides and halides exhibit adequate compressibility under pressure and easily reach high ionic conductivities ^{13,14}. Most of the sulfides and halides; however, are not cost-effective ¹⁵.

Recently zinc-based batteries have garnered attention as a cheaper and viable alternative to lithium batteries. Yang Chongyin, et. al., developed a new electrolyte that reportedly raises the efficiency of the zinc metal anode in zinc batteries by almost 100% ¹⁶. These zinc-based batteries are presented as a viable alternative to mainstream LIBs; however, they employ an aqueous (liquid) electrolyte. The cost-effectiveness and ease of handling and storage of zinc, as compared to lithium, makes it worthy of investigation as an electrode in all-solid-state batteries employing an appropriate solid-state electrolyte.

Aluminum has also been considered as an electrode material promising safer, cheaper, and more powerful batteries 17. The use of aluminum in electrode materials wasn't considered viable in mainstream LIBs with liquid electrolyte solutions, because of limited reversibility and other technical issues. Yuhgene Liu, et. al., recently reported the use of an aluminum-indium alloy as a negative electrode in an all-solid-state lithium-ion cell configuration employing a Li₆PS₅Cl solid-state electrolyte and a LiNi_{0.6}Mn_{0.2}Co_{0.2}O₂-based positive electrode, which they claim circumvents the technical problems while delivering hundreds of stable cycles and high current densities 17.

The preparation of the Al_{94.5}In_{0.5} foils presents its own set of challenges and disadvantages; however, in that their preparation involves melting of aluminum and indium at 800° C. in a MgO crucible within an argon (Ar)-filled glove box ¹⁷. Yuhgene Liu, et. al., also report subjecting the solid-state electrolyte, Li₆PS₅Cl, to pressures of 125 MPa in the assembly of their all-solid-state battery ¹⁷.

Cost-effective batteries employing unalloyed aluminum metal as a negative electrode have been reported, using elemental chalcogens (i.e. S, Se, Te) as the positive electrode 18. These batteries employ a liquid electrolyte; however, consisting of a molten-salt system, such as LiCl—NaCl—KCl that require operation at elevated temperatures ¹⁸.

A research team from Ulsan National Institute of Science and Technology recently developed an all-solid-state battery utilizing Prussian Blue analogs (PBAs) in combination with N-coordinated transition metal compounds as a solid-state electrolyte ¹⁹. In particular, Kim Taewon, et. al. developed an all-solid battery employing manganese-based PBAs with a sodium-tin (Na—Sn) alloy anode and a manganese carbide/nitride (MnCNMn) cathode that yielded a sodium ion conductivity of 0.1 mS·cm⁻¹ at room temperature ¹⁹. The research team discovered that the inherent properties of PBAs could enhance ionic conductivity, with different transition metals determining the size of the ion channels within the solid and; thus, affecting . . . conductivity ¹⁹.

### SUMMARY OF THE INVENTION

The present invention discloses solid-state electrolytes, which can be used in batteries employing any materials with a standard reduction/oxidation (redox) potential difference as the cathode and anode—i.e. their use is not restricted to lithium-based batteries. The disclosed electrolytes herein represent a significant improvement in the art of electrical energy storage, and they exhibit an ionic conductivity in excess of 3.5 mS·cm⁻¹, a compressibility enabling >90% density under 300 MPa of pressure, and at a cost of $20 to $50 per kilogram.

Accordingly, it is an objective of the present invention to provide novel inorganic solid-state electrolyte compositions. It is another objective to provide novel inorganic compounds to serve as the ion-conducting medium in electrical storage batteries, employing any materials with a redox potential difference as the cathode and anode in an electrochemical cell. Objectives of the invention having been stated hereinabove, other objectives will become evident as the description proceeds, when taken in connection with the accompanying Drawings and Laboratory Examples as best described hereinbelow.

### BRIEF DESCRIPTION OF THE DRAWINGS

References to Sample 1 in the drawings pertain to a sample of the electrolyte to which water was added as described in Laboratory Example 1. References to Sample 2 in the drawings pertain to the same sample of electrolyte, without the addition of any water, after its transition to the solid phase, upon removal from the applied magnetic field.

FIG. 1 and FIG. 2 show X-ray diffraction (XRD) data and the background curve for Samples 1 and 2, respectively. FIG. 3 and FIG. 4 show the profile fitting results for Samples 1 and 2, respectively. FIG. 4A is a continuation of the data included in FIG. 4. FIG. 5 compares the raw data from the two samples after they were ground into powders.

FIG. 6 is a schematic depiction of the top view of the uniform-direction magnetic field into which the controls were inserted during preparation of the electrolytes of the present invention.

FIG. 7 is a schematic depiction of the top view of the nonuniform-direction magnetic field into which the electrolytes of the present invention were successfully prepared. The numbers along the side of each of the drawings indicate the strength of the field line in milli Tesla (mT). The center of FIG. 7 has a field strength of 0 mT. The arrow marks on the field lines in FIG. 6 and FIG. 7 indicate the relative direction of the magnetic field along each line.

FIG. 8 is a depiction of the electrochemical cell-reactor into which the electrolytes of the present invention are placed in the liquid phase for the transition to the solid phase, after they have cooled to room temperature in the nonuniform magnetic field. The reactor consists of a carbon electrode and a metallic electrode, M, separated by 3.0 cm. and immersed into the electrolyte in its liquid phase at room temperature, with a conducting wire connecting the electrodes, all contained within a Pyrex glass vessel.

FIG. 9 is a depiction of an electrochemical cell, as prepared in Laboratory Example 2, consisting of two electrodes, M1 and M2, of materials with different redox potentials, separated by 3.0 mm of one of the SSEs of the present invention in between the electrodes.

### DETAILED DESCRIPTION OF THE INVENTION

### A. Definitions

As used herein, the following terms are meant to have their art-recognized meanings.

### 1. Transition Metal Cations

The transition metals are listed in the periodic table of elements in groups 4 to 12 and comprise the elements of atomic number 22 to 30, 40 to 48, 72 to 80, and 104 to 112. As used herein, reference to transition metals or transition metal ions will include only the following elements: chromium (Cr), manganese (Mn), iron (Fe), cobalt (Co), nickel (Ni), copper (Cu), zinc (Zn), zirconium (Zr), palladium (Pd), and cadmium (Cd). References to transition metal ions in the present invention refer to their +2, +3, or +4 oxidation states, depending on the element.

### 2. Rare-Earth Metal Cations

The rare-earth metals are scandium (Sc), yttrium (Y), and the lanthanides, which are the elements listed in the periodic table of elements having atomic number 21, 39, and 57 to 71, respectively. As used herein, reference to rare-earth metals or rare-earth metal ions will include only the following elements: yttrium (Y), lanthanum (La), cerium (Ce), praseodymium (Pr), neodymium (Nd), samarium (Sm), europium (Eu), gadolinium (Gd), terbium (Tb), dysprosium (Dy), holmium (Ho), and ytterbium (Yb). References to rare-earth metal ions in the present invention refer to the +3 oxidation state.

### 3. Other Relevant Terms

The alkali metals are in Group 1A of the periodic table of elements and consist of lithium (Li), sodium (Na), potassium (K), rubidium (Rb), cesium (Cs), and francium (Fr).

The terms inorganic, inorganic component, inorganic materials, etc. as used herein refer to substances that do not contain molecular compounds of the element carbon.

The term “container” as used herein refers to a Pyrex glass vessel.

The acronym IUPAC as used herein refers to the International Union of Pure and Applied Chemistry.

The standard reduction/oxidation (redox) potential as used herein refers to the IUPAC scale, measured in volts, which lists as half-reactions the relative free energies of elements (mostly metals) and compounds of elements according to their tendencies to either emit (oxidation) or capture (reduction) electrons in an electrochemical reaction.,

The term electrode as used herein refers to the component material in an electrochemical cell that yields (anode) or accepts (cathode) electrons.

An electrochemical cell as used herein refers to a device that transmutes electrical energy to chemical energy and vice-versa, consisting of two electrodes and an electrolyte.

The term electrolyte as used herein refers to the solid or liquid medium necessary for ion transfer in electrical energy-storage batteries (electrochemical cells).

Ionic conductivity as used herein is measured in milli-Siemens per centimeter (mS·cm⁻¹), and is a measure of the efficiency of ion transfer in an electrochemical cell.

Compressibility as used herein is a measure of the instantaneous relative volume change of a liquid or solid in response to a change in pressure.

Units of pressure herein are given in pascals (Pa), with MPa being a million (106) pascals. Atmospheric pressure is defined as 101,325 (1.01×10⁵) pascals.

References to Eurofins EAG herein refer to Eurofins EAG Materials Science, 810 Kifer Rd., Sunnyvale, CA. 94086, Tel. (408) 530-3829, an independent laboratory which furnishes chemical analysis services, and which conducted XRD analyses of samples submitted by the Inventor of the materials disclosed in the present invention.

The term Rietveld Refinement as used herein refers to the technique developed by Hugo Rietveld for use in the characterization of crystalline materials, which uses the profile intensities of the composite peaks in XRD data in a pattern-fitting method of structure refinement.

The height, width, and position of the peaks is used to determine the intermediate to long-term structure of materials.

The term least squares mean as used herein refers to a form of mathematical regression analysis used to determine the line or curve of best fit for a set of experimental data.

The acronyms ICDD and ICSD as used herein refer to the International Center for Diffraction Database and the Inorganic Crystal Structure Database, respectively.

### B. General Considerations

The inorganic solid-state electrolytes disclosed here are prepared from two solid-state components: a hydrated nitrate of a rare-earth metal and a hydrated salt of a transition metal. Each of the components are classified as coordination complexes, which are molecules having a central ion to which are attached one or more ligand molecules by coordination covalent bonds, also called dative bonds, in which both electrons in the covalent bond are provided by the same atom or molecule—i.e. the ligand. The molecular formulae of the starting components in the present invention are of the form R(NO₃)₃·6H2O and TₓA_{y}·zH₂O, where R is a rare-earth metal cation with electrical charge +3, T is a transition metal cation with electrical charge +2, +3, or +4, and A is one of the following anions: sulfate SO₄⁻², nitrate NO₃⁻, chloride Cl⁻, fluoride F⁻, chlorate ClO₃⁻, arsenate AsO₄⁻³, phosphate PO₄⁻³, perchlorate ClO₄⁻, selenite SeO₃⁻², or tetrafluoroborate BF₄⁻. The quantities x=1, 2 or 3; y=1, 2, 3, or 4; and z=1 to 18, depending on the respective electrical charges on the cation and anion in the molecule. The ligands in each of the components are water molecules, which are subject to hydrogen bonding.

A hydrogen bond is an intermolecular force that forms a special dipole-dipole attraction when a hydrogen atom bonded to a strongly electronegative atom with a lone pair of valence electrons—i.e. oxygen (O), nitrogen (N), or fluorine (F)—is in the vicinity of another O, N, or F atom. Hydrogen bonds are weaker than covalent or ionic bonds, but the hydrogen bonds involving water molecules are almost as strong as coordinate or dative bonds; therefore, the hydrogen bonding in a liquid melt of the complex R(NO)₃·6H₂O is almost as strong as the coordination bonds between the H₂O ligands and the central R⁺³ ion.

The coordination number (CN) of a coordination complex corresponds to the number of ligand molecules bonded to the central ion. For R(NO)₃·6H₂O, CN=6, and for TₓA_{y}·zH₂O, CN=1 to 9. The coordination complexes with CN=1, 2 and 9 are rare. The number CN=1 is only possible when a large central metal ion is surrounded by a very bulky organic ligand. The geometry CN=2 is linear; CN=3 is trigonal planar; CN=4 is tetrahedral or square planar; CN=5 is trigonal bipyramidal or square pyramidal. For CN=6, the geometry is octahedral, and this is the most stable configuration for transition metal complexes. The electrolytes disclosed here are composed of discrete octahedral molecular units in an intermediate to long-range structural order. According to ligand field theory, the five d-block atomic orbitals of a transition metal ion, that are at the same energy (i.e. degenerate orbitals) in a spherically symmetric field, will not be at the same energy in the octahedral-shaped field imposed by the presence of the ligands. The effect of the octahedral ligand field is to split the d-orbitals into two sets whose energies differ by some AE, depending on the identity of the ligands. Such orbital splitting is also observed in spectroscopy during atomic absorption or emission measurements when the ionic sample being measured is immersed in an externally applied magnetic field (the Zeeman effect).

As noted in the Background hereinabove, Taewon Kim, et. al., discovered the effect of transition metal coordination complexes on the size ion channels within the solid-state electrolyte, and they reported an ionic conductivity of 0.1 mS·cm⁻¹ in their electrolyte utilizing PBAs in combination with a manganese-based coordination compound ¹⁹. The solid electrolytes disclosed in the present invention exhibited an ion conductivity as high as 3.6 mS·cm⁻¹ at room temperature, using a 0.9% saline (sodium chloride) solution as a standard in the measurement. Furthermore, this measured value for ionic conductivity was obtained in an electrochemical cell using metallic anodes, such as copper, magnesium, zinc, and aluminum with a carbon cathode (see Laboratory Example 2), in contrast to the sodium-tin alloy anode utilized by Taewon Kim, et. al., in their all-solid-state battery. Sodium is one of the alkali metals, which are highly reactive and more difficult to handle than the materials that can be used for electrodes with the electrolytes disclosed herein.

Lv Hu, et. al., reported a solid electrolyte, Li_{1.75}ZrCl_{4.75}O_{0.5}, which shows an ionic conductivity of 2.42 mS·cm⁻¹ at 25° C. 10. Their published paper describes in detail how they arrived at this particular composition, starting with the assumption that an amorphous material, where multiple crystalline phases coexist, “might possibly enhance the properties relevant to solid electrolytes” (Hu, Lv, et. al., pg. 2). The formula Li_{1.75}ZrCl_{4.75}O_{0.5} is not a molecular formula, which do not have fractional subscripts, but represents a mixture of three compounds: Li₂ZrCl₆, Li₄ZrCl₄O₂, and LiZrCl₅, so that the general formula is (1-a-b) Li₂ZrCl₆-aLi₄ZrCl₄O₂-bLiZrCl₅. From a ternary phase diagram and using XRD analysis, Lv Hu, et. al., concluded that the ionic conductivity of their electrolyte was directly proportional to the degree of amorphism, i.e. low crystallinity (<20%) of the composition (Hu, Lv, et. al., pg. 5). While this conclusion may be true for the oxychloride solid-state electrolyte prepared by Lv Hu, et. al., even they admit that “the atomic configuration of the amorphous species is too complicated to be precisely studied by the present experimental or computational techniques, making it very difficult to conduct in-depth discussion on the microscopic origin of the ionic conductivity improvement associated” with the composition's amorphism (Hu, Lv, et. al., pg. 5). Furthermore, the XRD analysis conducted by Eurofins EAG of samples of the electrolytes, disclosed herein, exhibited a crystallinity of 100% (see Table 1), and they measure an ionic conductivity of 3.6 mS·cm⁻¹ as stated hereinabove.

A more accurate correlation of the composition of a solid-state electrolyte to its ionic conductivity is that proposed by Taewon Kim, et. al.—i.e. the nature and size of the ion channels within the electrolyte, which they determined was dependent upon the transition metal coordination compound used with PBAs ¹⁹. The ion channels within a solid-state electrolyte can be tailored to the electrodes being used in an all-solid-state battery, in order to maximize the energy density, by the selection of an appropriate transition metal coordination compound as a component of the SSE.

In addition to exhibiting a high ionic conductivity, an SSE generally must be easily compressible under pressure. This requirement is related to the extent of solid-solid contact between the electrolyte and the electrodes in the electrochemical cell. Compressibility is not a factor with liquid electrolytes, because the fluidity of the liquid phase ensures maximum contact between the atoms of the electrolyte and the electrodes. Although the compressibility of the SSEs in the present invention satisfy the compressibility requirement, measuring in excess of 90%, this is actually irrelevant here, because the low melting points of the electrolytes (<100° C.) allows them to be applied by pouring, painting, or spraying as a liquid aerosol onto the surfaces of the electrodes. As described in Laboratory Example 2 hereinbelow, smooth aluminum foils were effortlessly bonded to the surfaces of copper and zinc by pouring the melted SSE onto one surface, sandwiching the melted electrolyte with the other electrode, and allowing the cell to cool to room temperature.

The SSEs disclosed in the present invention are prepared at atmospheric pressure, which is about 1000 times less than the pressures reported by Yuhgene Liu, et. al., in the assembly of their all-solid-state battery 19. The use of cost-effective, safer, and easier to handle materials, such as aluminum, zinc, sulfur etc. in batteries that can compete with traditional LIBs in terms of energy density represents a significant deficiency in the art of electrical energy storage. The solid-state electrolytes disclosed herein, and the all-solid-state batteries that can be assembled using them, satisfy this deficiency.

### X-Ray Diffraction Analysis Report

Purpose: Use x-ray diffraction to identify the phase(s) present, determine the percent crystallinity, average crystallite size and texture orientation, if possible, in both a liquid and solid sample. The samples were identified as indicated in Table 1.

### Results

TABLE 1
Phase identification, Lattice constants,
Crystallite size and % Crystallinity

| | | Average | |
|---|---|---|---|
| | | crystallite | |
| Sample ID | Phases Identified | size (nm) | % Crystallinity |
| Sample 1 | Amorphous materials | N/A | N/A |
| (as is Liquid) | | | |
| Sample 1 | La(NO₃)₃(H₂O)₆ - | 148.0 +/− 5.5 | 100.0% |
| (dried and | Lanthanum | | |
| ground | Nitrate Hydrate, with | | |
| crystals) | a~8.9259 (14.5) Å | | |
| | b~10.7063 (14.5) Å | | |
| | c~6.6489 (14.5) Å | | |
| | Triclinic, S.G.: P-1 (2) | | |
| | [PDF# 04-011-0397] | | |
| Sample 2 | Unindexing pattern | N/A | N/A |
| (as is Solid) | | | |
| Sample 2 | La(NO₃)₃(H₂O)₆ - | 110.7 +/− 2.1 | 100.0% |
| (Ground | Lanthanum | | |
| solids) | Nitrate Hydrate, with | | |
| | a~8.9216 (8.8) Å | | |
| | b~10.7035 (8.8) Å | | |
| | c~6.6480 (8.6) Å | | |
| | Triclinic, S.G.: P-1 (2) | | |
| | [PDF# 04-011-0397] | | |

### C. Composition of the Preferred Embodiments

In accordance with the present invention, the nature of the inorganic components is the primary variable upon which the structural order of the materials disclosed here depends. A melted solid crystalline coordination complex of molecular formula R(NO₃)₃·6H₂O is used as a solvent, where R represents a cation from one of the following elements: yttrium (Y), lanthanum (La), cerium (Ce), praseodymium (Pr), neodymium (Nd), samarium (Sm), europium (Eu), gadolinium (Gd), terbium (Tb), dysprosium (Dy), holmium (Ho), and ytterbium (Yb). These rare-earth nitrates provide an appropriate solvent for the preparation of the electrolytes in the present invention, as they all melt at a temperature less than the boiling point of water (100° C.).

TABLE 2
Melting Points of Selected Rare-Earth Metal Nitrates (° C.)

| | | | |
|---|---|---|---|
| Y(NO₃)₃•6H₂O | 51.8 | Dy(NO₃)₃•6H₂O | 88.6 |
| La(NO₃)₃•6H₂O | 69.9 | Yb(NO₃)₃•6H₂O | 51.8 |
| Ce(NO₃)₃•6H₂O | 65.0 | Ho(NO₃)₃•6H₂O | 91.5 |
| Eu(NO₃)₃•6H₂O | 65.0 | Nd(NO₃)₃•6H₂O | 40.0 |
| Pr(NO₃)₃•6H₂O | 58.0 | Gd(NO₃)₃•6H₂O | 91.0 |
| Tb(NO₃)₃•6H₂O | 89.3 | Sm(NO₃)₃•6H₂O | 78.5 |

At temperatures less than 100° C., the integrity of the structure of the coordination complexes, with their ligands of H₂O, remains undisturbed.

A solid-state crystalline coordination complex of molecular formula TₓA_{y}·zH₂O is added as a solute to the melted rare-earth metal nitrate to the point of saturation—i.e. when the solute no longer dissolves. T is a transition metal cation with electrical charge +2, +3, or +4, and A is one of the following anions: sulfate SO₄⁻², nitrate NO₃⁻, chloride Cl⁻, fluoride F″, chlorate ClO₃⁻, arsenate AsO₄⁻³, phosphate PO₄⁻³, perchlorate ClO₄⁻, selenite SeO₃⁻², or tetrafluoroborate BF₄⁻. The quantities x=1, 2 or 3; y=1, 2, 3, or 4; and z=1 to 18, depending on the respective electrical charges on the cation and anion in the molecule. The ligands in each of the components are water molecules, which are subject to hydrogen bonding.

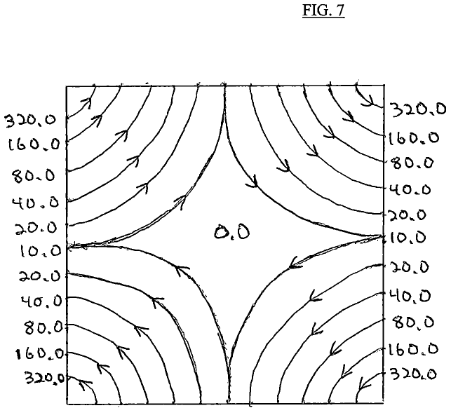

The resulting solution of hydrated transition metal salt in hydrated rare-earth metal nitrate is heated to 90° C., and the liquid is separated from excess hydrated transitional metal salt and poured into a second container already immersed in a magnetic field (see FIG. 7 and the laboratory examples herein below) where it is allowed to slowly cool to room temperature. The solution in the second container will be approximately 40:1 by weight of hydrated rare-earth metal nitrate to hydrated transition metal salt.

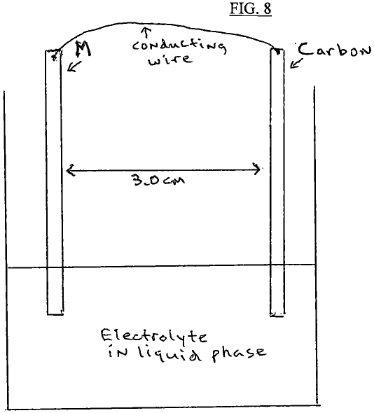

At room temperature, suitable electrodes are inserted into the liquid electrolyte with a conducting wire connecting the electrodes (see FIG. 8 and Laboratory Example 2). The liquid electrolyte will transition to the solid phase and release heat shortly after the electrodes are inserted, thereby disturbing the metastable liquid phase (see Laboratory Example 1). The resulting solid is stable and can be stored without any special procedures until it is used.

The SSEs of the present invention all have melting points less than 100° C., and they can be melted and applied as liquids to any electrode surfaces. If they are used in electrochemical cells employing lithium metal or other alkali metals as electrode components, a thin layer (˜0.315 mm) of Li₆PS₅Cl or other suitable material can be applied to the electrode to prevent reaction between the SSE and alkali metal, as was done by Lv Hu, et. al., in the assembly of their electrochemical cell ¹⁰ (Hu, Lv, et. al., pg. 7).

### D. Laboratory Examples

### Laboratory Example 1: Copper (II) Sulfate Pentahydrate in Lanthanum (III) Nitrate Hexahydrate

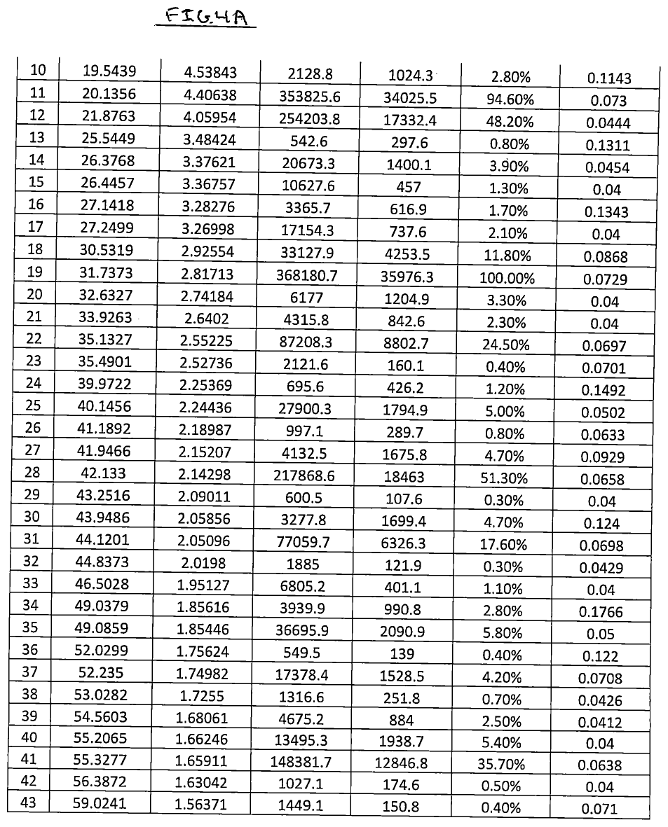

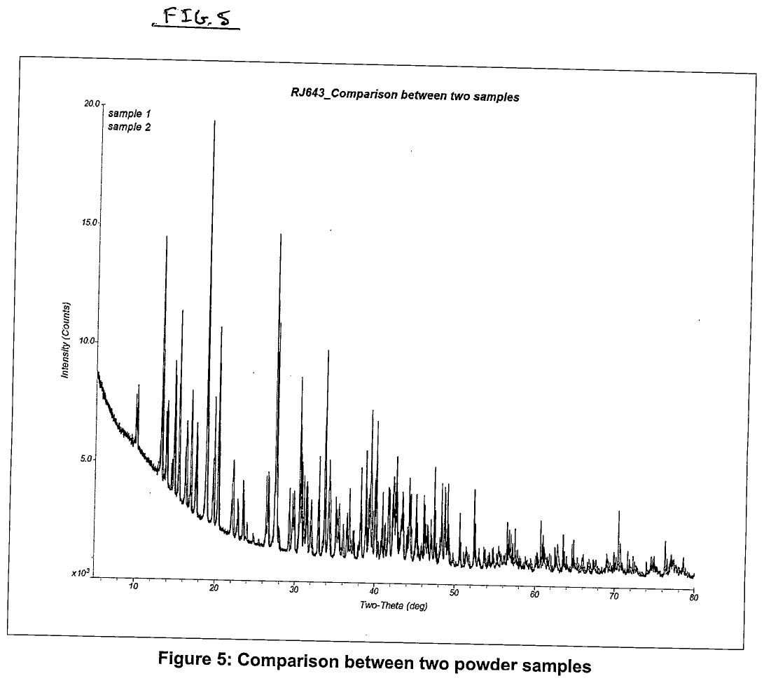

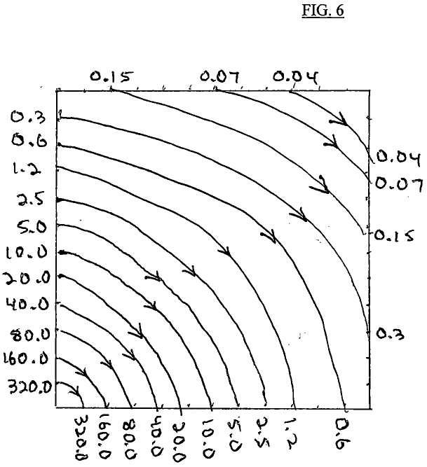

Powdered copper sulfate pentahydrate was added to a melt of lanthanum nitrate hexahydrate to saturation. The resulting mixture was heated to 90° C. and the liquid was separated from excess copper sulfate and placed into three separate containers. One container was immersed in a magnetic field as shown in FIG. 7. A second container was immersed in a magnetic field as shown in FIG. 6. The magnetic field was provided by a cubic cage of a permanent neodymium (Nd₂Fe₁₄B) magnet open at the top and bottom. The samples were immersed in the field so that the top of the liquid in the container was level with the top of the cage. The third container was not in any magnetic field. The solutions were allowed to slowly cool to room temperature. The sample in the second container, immersed in uniform-direction magnetic field as shown in FIG. 6, solidified prior to reaching room temperature. The samples in the other two containers remained in the liquid phase at room temperature. After a few hours, the sample in the isolated container, not immersed in any field during preparation, transitioned to the solid phase and released heat, with the temperature rising to 57° C. from room temperature. The sample in the container that had been immersed during preparation in the nonuniform-direction magnetic field, as shown in FIG. 7, remained in the liquid phase until it was disturbed by insertion of the electrodes in the electrochemical cell-reactor (see FIG. 8 and Laboratory Example 2), whereupon it transitioned to the solid phase with a release of heat. A portion of the solid electrolyte was removed from the electrochemical-reactor and melted and a quantity of water was added to the liquid in proportions ranging from 0.14 g to 0.18 g of H₂O per gram of hydrated rare-earth metal nitrate contained in the liquid, and this portion was forwarded to Eurofins EAG as Sample 1. A portion of the solid electrolyte to which no water was added was submitted to Eurofins EAG as Sample 2.

### Laboratory Example 2: Electrochemical Cells

The electrolyte in Laboratory Example 1 in the liquid phase was placed in an electrochemical cell-reactor using copper metal as the anode and a carbon cathode (see FIG. 8). The liquid immediately began transitioning to the solid phase upon insertion of the electrodes, and the temperature rose from room temperature (˜25° C.) to 57° C. The electrodes were connected by a copper wire, as shown in FIG. 8, and the cell yielded 0.4 V, which decreased in direct proportion to the decrease in temperature of the electrolyte as it cooled to room temperature. After the electrolyte cooled back down to room temperature, the resulting electrochemical cell yielded 0.1 V with an electrode separation of 3.0 cm. in the solid electrolyte. An 0.9% sodium chloride solution used as the electrolyte in the same cell-reactor using the same electrodes yielded 0.4 V at room temperature.

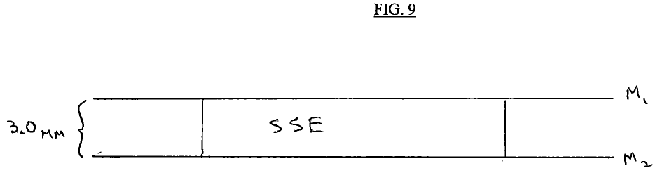

Several electrochemical cells were assembled with metal electrodes using the SSE prepared in Laboratory Example 1 by melting the electrolyte and pouring a portion onto the surface of one electrode (M1) and then placing the other electrode (M2) on top, forming a sandwich of the melted solid between the electrodes at a separation of 3.0 mm. (see FIG. 9). The following electrode combinations were assembled in this manner: 1.) M₁=Mg, M₂=Zn; 2.) M₁=Al, M₂=Zn; 3.) M₁=Zn, M₂=Cu; 4.) M₁=Al, M₂=Cu; 5.) M₁=Mg, M₂=Cu; and 6.) M₁=Al, M₂=Fe. After cooling to room temperature (˜25° C.), the voltages of each these cells measured at approximately 0.4 V. This indicates that, regardless of the electrodes used in the electrochemical cell, the voltage of the cell reaches a plateau dependent upon the saturation of the ion channels in the particular SSE in the cell. The nature and size of the ion channels in the SSE are, in turn, a function of the particular transition metal coordination compound used as a component in the SSE ¹⁹.

### Laboratory Example 3: X-Ray Crystallography

Samples 1 and 2 were prepared in accordance with Laboratory Example 1. Sample 1 was pipetted on a special zero-background sample holder while Sample 2 was placed onto an adjustable height sample stage of the diffractometer for analysis; then a dried quantity of Sample 1 and a quantity of the solid Sample 2 were placed on a special low-background cup for analysis. X-ray diffraction (XRD) data was collected by a two-theta scan on a Rigaku Smartlab diffractometer equipped with a copper X-ray tube with Ni beta filter, parafocusing (Bragg-Brentano) optics, computer-controlled slits, and a D/teX 1D strip detector. Crystalline phases (or systems), percent crystallinity, average crystallite size, and the crystal lattice constants for the tested samples are listed in Table 1 hereinabove.

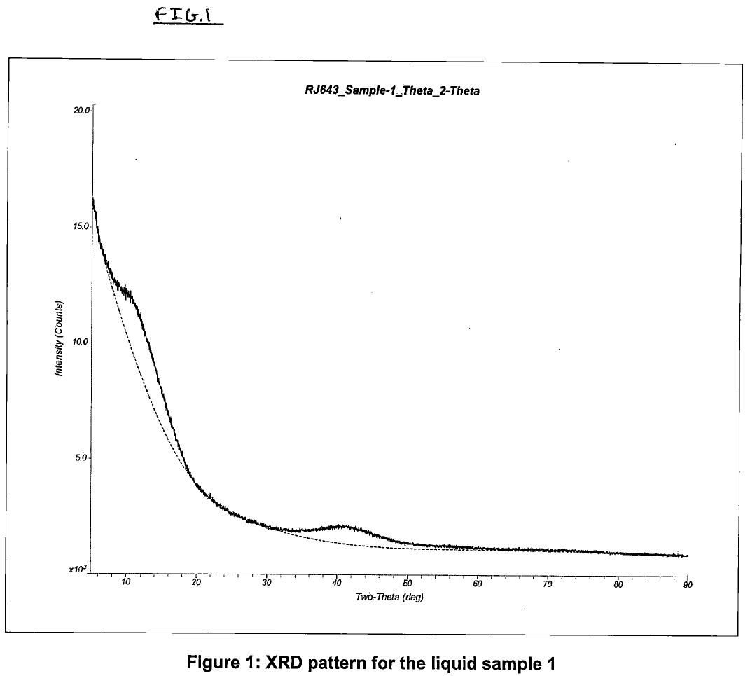

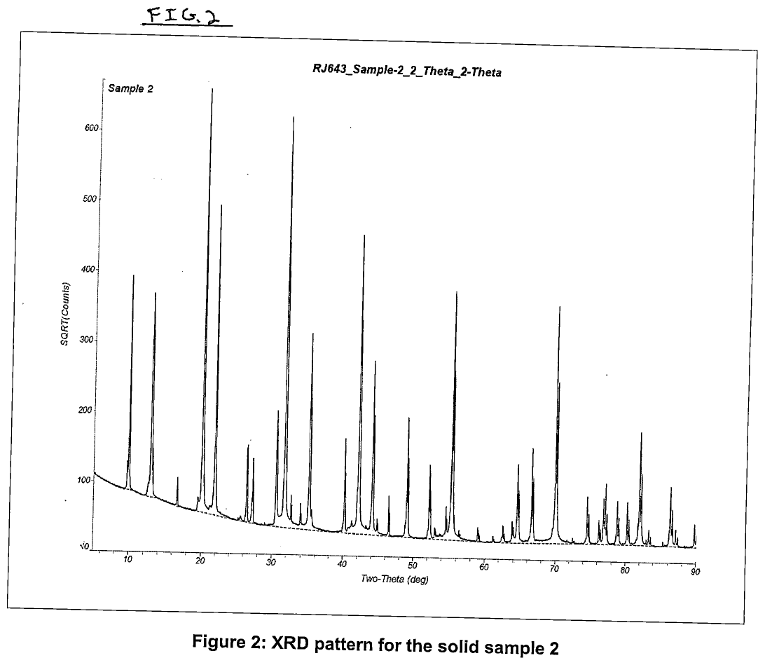

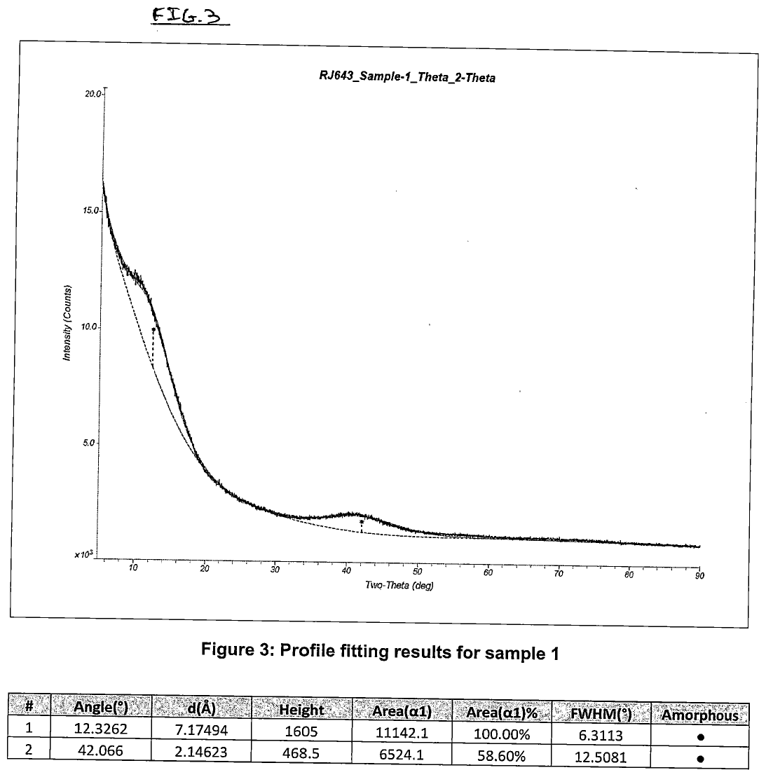

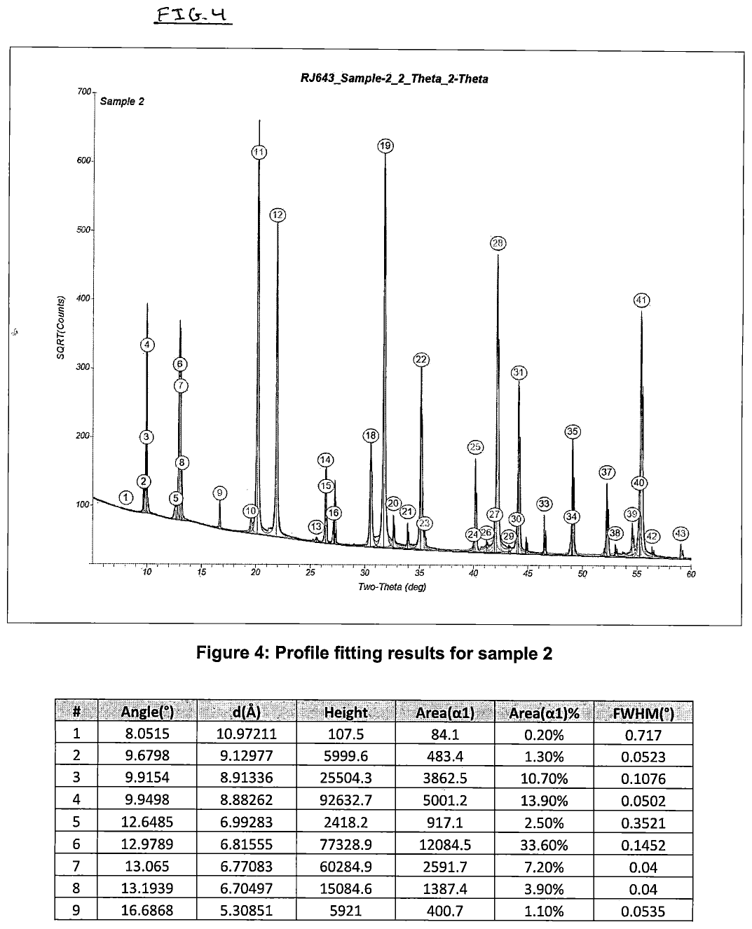

The two main broad peak shape in FIG. 1 indicates that the liquid Sample 1 is completely amorphous. The amorphous nature of Sample 1 is the expected result of the stabilization of the liquid phase by the addition of water to the electrolyte in the preparation of the sample (see Laboratory Example 1). Because of the amorphous nature of Sample 1, there was no basis for comparison of the data of the sample to the ICDD or ICSD databases; however, the experimental data for Sample 2 (see FIG. 2), which was classified as crystalline by Eurofins EAG Materials, was compared to these databases, and no satisfactory matches were found, which supports the novelty of the materials in the present invention.

A quantity of the liquid Sample 1 was dried and ground into a powder. A comparison of raw XRD data from powdered Samples 1 and 2 (FIG. 5) show general similarity except for the difference in overall intensities and peak shape. These differences, when considered in conjunction with the significant difference in crystallite size (see Table 1), which was determined by modeling the peaks in the XRD patterns and translating the Full Width of Half Maximum (FWHM) of each peak directly to crystallite size, indicates that a contraction in the spacing of the crystal lattice planes occurs in the transition of the electrolyte from the liquid to the solid phase upon destabilization. The dried and powdered Sample 1 exhibited an average crystallite size of 148.0+/−5.5 nM, and that for Sample 2 was 110.7+/−2.1 nM (see Table 1).

Semi-quantitative analysis was performed using whole pattern fitting (WPF), which is a subset of Rietveld Refinement that accounts for all intensity above a background curve. During this process, structure factor (which relates to concentration), lattice parameters (which relate to XRD peak position), peak width and peak shape are refined for each phase to minimize the R value—an estimate of the agreement between the least square mean and the experimental data over the entire pattern. The R values for these refinements, at 10.34% for Sample 1 and 5.92% for Sample 2 are quite good and reasonable given such complex patterns, according to Eurofins EAG Material Science.

Crystalline phases (see Table 1) were identified by comparing the location and relative intensity of peaks present in background-modeled experimental XRD data to entries in the ICDD/ICSD databases. According to Eurofins EAG, the technique of XRD is sensitive to crystal structure but relatively insensitive to elemental or chemical state composition. The quantity of hydrated transition metal sulfate in the samples sent to Eurofins EAG was in a proportion of 1 to 40 by weight to the hydrated rare-earth metal nitrate (see Composition of the Preferred Embodiments hereinabove), and consequently its effect on the XRD results was negligible and the phase (or system) identified was the triclinic lanthanum nitrate hexahydrate, whose ICDD/ICSD reference pattern was superimposed on the experimental data (see Table 1) and determined to be the closest match for both samples.

1. An inorganic electrolyte composed of two inorganic compounds: (a) a hydrated rare-earth metal nitrate with molecular formula R(NO₃)₃·6H₂O and (b) a hydrated transition metal sulfate with molecular formula TSO₄·nH₂O, wherein R is the cation with +3 electrical charge of one of the following rare-earth metals: yttrium (Y), lanthanum (La), cerium (Ce), praseodymium (Pr), neodymium (Nd), samarium (Sm), europium (Eu), gadolinium (Gd), terbium (Tb), dysprosium (Dy), holmium (Ho), and ytterbium (Yb); T is a cation with +2 electrical charge of one of the following transition metals: manganese (Mn), cobalt (Co), nickel (Ni), copper (Cu), zinc (Zn), palladium (Pd), and cadmium (Cd); and n=1 to 9.

2. The electrolyte in claim 1, wherein the transition metal component is a hydrated transition metal sulfate with molecular formula T2 (SO₄)₃·nH₂O; T is a cation with +3 electrical charge of iron (Fe) or chromium (Cr); and n=1 to 18.

3. The electrolyte in claim 1, wherein the transition metal component is zirconium sulfate with molecular formula Zr(SO₄)₂·nH₂O and n=1 to 9.

4. The electrolyte in claim 1, wherein the transition metal component is a hydrated transition metal chloride with molecular formula TCl₂·nH₂O; T is a cation with +2 electrical charge of one of the following transition metals: manganese (Mn), cobalt (Co), nickel (Ni), copper (Cu), zinc (Zn), palladium (Pd), and cadmium (Cd); and n=1 to 9.

5. The electrolyte in claim 1, wherein the transition metal component is a hydrated transition metal chloride with molecular formula TCl₃·nH₂O; T is a cation with +3 electrical charge of iron (Fe) or chromium (Cr); and n=1 to 9.

6. The electrolyte in claim 1, wherein the transition metal component is zirconium chloride with molecular formula ZrCl₄·nH₂O and n=1 to 9.

7. The electrolyte in claim 1, wherein the transition metal component is a hydrated transition metal fluoride with molecular formula TF₂·nH₂O; T is a cation with +2 electrical charge of one of the following transition metals: manganese (Mn), cobalt (Co), nickel (Ni), copper (Cu), zinc (Zn), palladium (Pd), and cadmium (Cd); and n=1 to 9.

8. The electrolyte in claim 1, wherein the transition metal component is a hydrated transition metal fluoride with molecular formula TFl₃·nH₂O; T is a cation with +3 electrical charge of iron (Fe) or chromium (Cr); and n=1 to 9.

9. The electrolyte in claim 1, wherein the transition metal component is zirconium fluoride with molecular formula ZrFl₄·nH₂O and n=1 to 9.

10. The electrolyte in claim 1, wherein the transition metal component is a hydrated transition metal nitrate with molecular formula T(NO₃)₂·nH₂O; T is a cation with +2 electrical charge of one of the following transition metals: manganese (Mn), cobalt (Co), nickel (Ni), copper (Cu), zinc (Zn), palladium (Pd), and cadmium (Cd); and n=1 to 9.

11. The electrolyte in claim 1, wherein the transition metal component is a hydrated transition metal nitrate with molecular formula T(NO₃)₃·nH₂O; T is a cation with +3 electrical charge of iron (Fe) or chromium (Cr); and n=1 to 9.

12. The electrolyte in claim 1, wherein the transition metal component is zirconium nitrate with molecular formula Zr(NO₃)₄·nH₂O and n=1 to 9.

13. The electrolyte in claim 1, wherein the transition metal component is a hydrated transition metal chlorate with molecular formula T(ClO₃)₂·nH₂O; T is a cation with +2 electrical charge of one of the following transition metals: manganese (Mn), cobalt (Co), nickel (Ni), copper (Cu), zinc (Zn), palladium (Pd), and cadmium (Cd); and n=1 to 9.

14. The electrolyte in claim 1, wherein the transition metal component is a hydrated transition metal chlorate with molecular formula T(ClO₃)₃·nH₂O; T is a cation with +3 electrical charge of iron (Fe) or chromium (Cr); and n=1 to 9.

15. The electrolyte in claim 1, wherein the transition metal component is zirconium chlorate with molecular formula Zr(ClO₃)₄·nH₂O and n=1 to 9.

16. The electrolyte in claim 1, wherein the transition metal component is a hydrated transition metal perchlorate with molecular formula T(ClO₄)₂·nH₂O; T is a cation with +2 electrical charge of one of the following transition metals: manganese (Mn), cobalt (Co), nickel (Ni), copper (Cu), zinc (Zn), palladium (Pd), and cadmium (Cd); and n=1 to 9.

17. The electrolyte in claim 1, wherein the transition metal component is a hydrated transition metal perchlorate with molecular formula T(ClO₄)₃·nH₂O; T is a cation with +3 electrical charge of iron (Fe) or chromium (Cr); and n=1 to 9.

18. The electrolyte in claim 1, wherein the transition metal component is zirconium perchlorate with molecular formula Zr(ClO₄)₄·nH₂O and n=1 to 9.

19. The electrolyte in claim 1 wherein the transition metal component is the hydrated transition metal selenite with molecular formula TSeO₃·nH₂O, wherein T is a cation with +2 electrical charge of one of the following transition metals: manganese (Mn), cobalt (Co), nickel (Ni), copper (Cu), zinc (Zn), palladium (Pd), and cadmium (Cd); and n=1 to 9.

20. The electrolyte in claim 1, wherein the transition metal component is a hydrated transition metal selenite with molecular formula T₂(SeO₃)₃·nH₂O; T is a cation with +3 electrical charge of iron (Fe) or chromium (Cr); and n=1 to 18.

21. The electrolyte in claim 1, wherein the transition metal component is zirconium selenite with molecular formula Zr(SeO₃)₂·nH₂O and n=1 to 9.

22. The electrolyte in claim 1, wherein the transition metal component is a hydrated transition metal tetrafluoroborate with molecular formula T(BF₄)₂·nH₂O; T is a cation with +2 electrical charge of one of the following transition metals: manganese (Mn), cobalt (Co), nickel (Ni), copper (Cu), zinc (Zn), palladium (Pd), and cadmium (Cd); and n=1 to 9.

23. The electrolyte in claim 1, wherein the transition metal component is a hydrated transition metal tetrafluoroborate with molecular formula T(BF₄)₃·nH₂O; T is a cation with +3 electrical charge of iron (Fe) or chromium (Cr); and n=1 to 9.

24. The electrolyte in claim 1, wherein the transition metal component is zirconium tetrafluoroborate with molecular formula Zr(BF₄)₄·nH₂O and n=1 to 9.

25. The electrolyte in claim 1, wherein the transition metal component is a hydrated transition metal arsenate with molecular formula T₃(AsO₄)₂·nH₂O; T is a cation with +2 electrical charge of one of the following transition metals: manganese (Mn), cobalt (Co), nickel (Ni), copper (Cu), zinc (Zn), palladium (Pd), and cadmium (Cd); and n=1 to 9.

26. The electrolyte in claim 1, wherein the transition metal component is a hydrated transition metal arsenate with molecular formula TAsO₃·nH₂O; T is a cation with +3 electrical charge of iron (Fe) or chromium (Cr); and n=1 to 9.

27. The electrolyte in claim 1, wherein the transition metal component is zirconium arsenate with molecular formula Zr₃ (AsO₄)₄·nH₂O and n=1 to 9.

28. The electrolyte in claim 1, wherein the transition metal component is a hydrated transition metal phosphate with molecular formula T₃ (PO₄)₂·nH₂O; T is a cation with +2 electrical charge of one of the following transition metals: manganese (Mn), cobalt (Co), nickel (Ni), copper (Cu), zinc (Zn), palladium (Pd), and cadmium (Cd); and n=1 to 9.

29. The electrolyte in claim 1, wherein the transition metal component is a hydrated transition metal phosphate with molecular formula TPO₃·nH₂O; T is a cation with +3 electrical charge of iron (Fe) or chromium (Cr); and n=1 to 9.

30. The electrolyte in claim 1, wherein the transition metal component is zirconium phosphate with molecular formula Zr₃ (PO₄)₄·nH₂O and n=1 to 9.

31. The method of preparation of the compositions in claims 1 to 30 wherein the hydrated rare-earth metal component is melted and serves as a solvent into which the solid-state hydrated transition metal component is dissolved to the point of saturation, and the liquid is separated from excess transition metal salt and placed in a magnetic field to slowly cool to room temperature.

32. The method of preparation in claim 31 wherein the magnetic field applied to the liquid during cooling is of specific geometry, as in FIG. 7 of the Drawings, such that the direction and magnitude of the magnetic field varies in different regions or domains of the liquid as it cools to room temperature.

33. The method of preparation in claims 31 and 32 wherein the liquid solution is placed in an electrochemical cell-reactor, as depicted in FIG. 8, and two electrodes are immersed into the liquid at room temperature, with the electrodes joined by a connecting, electrically conducting wire at points not immersed in the electrode, as the liquid transitions to the solid phase.

34. The method of preparation of electrolytes in claims 31, 32, and 33 wherein the components consist solely of the hydrated rare-earth metal nitrates, as set forth in claim 1, either as a single component or as a combination of components.

35. The use of the preparations in claims 1 to 30 or the methods in claims 31 to 34 in any process for the development or manufacturing of electrolytes, electrodes, all-solid-state batteries, or other electrical energy storage devices or their components, where such use is a necessary part of the process.
